(19) United States
(12) Patent Application Publication
(10) Pub. No.: US 2026/0295979 A1
(43) Pub. Date: Oct. 1, 2026

(54) WOOD-BASED MATERIAL PANEL WITH AT LEAST ONE DEPRESSION EMBOSSED INTO THE UPPER SURFACE

(71) Applicant: FLOORING TECHNOLOGIES LTD., Ricasoli, Kalkara (MT)

(72) Inventors: Norbert Kalwa, Horn-Bad Meinberg (DE); Georg Seidack, Wittstock/Dosse (DE)

(21) Appl. No.: 19/477,648

(22) PCT Filed: Jun. 28, 2024
(86) PCT No.: PCT/EP2024/068364

§ 371 Date: Oct. 22, 2025

(30) Foreign Application Priority Data
Jun. 29, 2023 (EP) 23182476.4

(51) Int. Cl. B32B 21/06; B32B 3/30; B32B 21/02; B32B 38/06

(52) U.S. Cl. CPC B32B 21/06; B32B 3/30; B32B 21/02; B32B 38/06; B32B 2255/12; B32B 2255/26; B32B 2307/718; B32B 2307/7375; B32B 2419/04

(57) ABSTRACT

The disclosure relates to a wood-based material panel with a core, at least one decorative layer lying on an upper side above the core, under which at least one underlay sheet made of resin-coated paper is provided, at least one cover layer lying above the decorative layer, and at least one depression embossed into the upper side, where the resin is a mixed resin made of phenolic resin and melamine resin.

### FIELD OF INVENTION

The invention relates to a wood-based material panel with a core, at least one decorative layer lying on an upper side above the core, under which at least one underlay sheet made of resin-coated paper is provided, at least one cover layer lying above the decorative layer, and at least one depression embossed into the upper side.

### BACKGROUND

Nowadays, numerous design effects are used in modern laminate floorings in order to visually enhance the product or to come even closer to the pattern of parquet flooring or real wood flooring. Technical changes are also carried out on the product in order to render sustained use less problematic. Examples of this include the use of digital printers to produce wood reproductions without repeating patterns, improving connection profiles to prevent water penetration, and designing element edges with chamfering (bevels). This design element has also been borrowed from real-wood floors. It has two functions. On the one hand, the chamfer visually breaks up the appearance when laid; on the other, machine-related height tolerances are concealed. However, the chamfer also creates a weak point, which makes it easier for water to penetrate into the connecting area of the floor element. The chamfer can be sealed with the aid of colored varnishes, but this seal is generally not water-tight. This means that if this area is often exposed to water, e.g. due to care and maintenance, swelling may occur.

In order to avoid this issue, attempts have been made to pre-structure the coating of the wood-based material carrier in a short-cycle press using melamine impregnates and deep-structured embossing plates in the area that would later become a chamfer. The chamfer would then remain as a melamine coating during processing or profiling of the lateral edges.

EP 3 578 383 A1 describes a method in which a relief in the form of at least one strip-shaped depression is embossed into the upper side of an HDF panel in a first embossing step; a tempering agent is first applied to the upper side, followed by an underlay sheet made of resin-impregnated paper, on top of which a decorative paper is then applied, followed by an overlay paper on top of the decorative paper as an abrasion-resistant layer. This structure is fed to a press and pressed at high pressure and a high temperature. During pressing, a second embossing step is performed on the at least one strip-shaped depression without changing the depth. The pressed HDF panel is subsequently divided into individual panels by carrying out a saw cut along the depressions. Such panels can be used as flooring panels, or as wall or ceiling panels. They often feature a wood, stone or fantasy decoration with a superimposed, three-dimensional surface.

To ensure that a chamfer is visible, the depth of the depression has to be between 0.4 to 0.5 mm. To produce the depression, embossing calendar rolls can be used, which work at a pressure of up to 600 N/mm² and a surface temperature of up to 220°. A short-cycle press with a deep-structured press plate can also be used, preferably with strip-shaped elevations on the press plate.

The known method does provide the technique for pressing the chamfer, but other problems remain. The wood-based material panel, especially fiberboard, that forms the core and acts as a carrier material exhibits a so-called spring-back effect during pressing with deep-structured plates. This means that, after pressing, the wood-based material panels do not have the structure depth of the plate, but only approximately 60% of the embossed structure depth. This depends on the elasticity of the wood-based material panel that is compressed in the short-cycle press and partially rises again following decompression. As a result, it is necessary to structure the press plate significantly more deeply in order to create the desired structure depth in the subsequent product.

A further problem is that in the areas where deep structuring occurs, the melamine resin papers used for the at least one underlay sheet, the decoration and the overlay tend to tear due to overextension. Attempts have been made to use strip-shaped impregnates, but these are difficult to position on the wood-based material panel. Ultimately, the target devices on the short-cycle presses are not designed for laying strip-shaped impregnates either. The pre-laid impregnation channels cannot create such strip-shaped impregnates, which leads to an additional process step following impregnation.

It is also often observed that disruptions to transparency occur in the deep-structured areas of the wood-based material panel. Micro-tears may also be determined in the structuring.

### SUMMARY

On this basis, a wood-based material panel according to the preamble is to be improved in such a way that the at least one embossed depression is as deep as possible and its depth is at least 0.4 mm, without significantly altering the pressing conditions normally used on a short-cycle press or making considerable technical changes to the pre-products in advance (impregnates, wood-based material panels, fiberboards).

In order to solve the problem, a wood-based material panel according to the preamble is characterized in that the resin is a mixed resin composed of phenolic resin and melamine resin.

As was surprisingly demonstrated during the pressing process, this leads to significantly improved results. In comparison to standard embossed wood-based material panels, not only can a considerably smaller spring-back effect be observed, but the problems concerning the development of tears and disruptions to transparency were also significantly reduced or did not occur at all any more.

It has been proven to be particularly positive if the ratio of phenolic resin to melamine resin is 2:1. This preferably refers to the weight ratio between the phenolic resin and melamine resin.

During trials, it was determined that eliminating the problem depends considerably on the grammage of the underlay sheet. The higher the grammage of the underlay sheet, the deeper the structure could be made to be and the lower the amount of tear development or disruption to transparency was observed. The weight of the paper sheet is therefore preferably 80 to 260 g/m² and the paper is preferably coated (impregnated) with the mixed resin in a quantity of 60 to 200 g/m².

If the paper weight is 80 g/m², it is advantageous to coat it with at least 60 g/m² of mixed resin.

If the paper weight is 100 g/m², it is advantageous to coat the paper with at least 75 g/m², and if the paper weight is, for example, 160 g/m², it is particularly advantageous if the paper is coated with 120 m/g² mixed resin.

It is advantageous if at least one further embossed depression is provided, which is at a 90° diagonal angle to the depression. Panels can then be cut out of the wood-based material panel along these depressions. It is particularly advantageous if a plurality of depressions is provided which extend parallel to each other. The number of panels to be cut from the wood-based material panel increases as a result.

The depressions preferably have a depth of at least 0.4 mm. The chamfer is then clearly visible on the end product.

Preferably, the decorative layer is also made of a resin-impregnated decorative paper which, in particular, has a weight of 60 to 160 g/m².

The cover layer is also preferably made of a resin-impregnated overlay paper.

It has been proven particularly advantageous if an HDF panel (high density fiberboard) is used as a core.

A floor panel that has been produced after dividing the wood-based material panel along the depressions and possibly after further machining steps for profiling the edges is characterized on the lateral edges of the decoration by a chamfer that extends towards the edge profiling and is reduced to a depth of at least 0.4 mm.

### BRIEF DESCRIPTION OF DRAWINGS

An embodiment example of the invention will be explained in more detail with the aid of accompanying figures.

They show:

FIG. 1 shows a cut through a large-scale wood-based material panel in the longitudinal direction;

FIG. 2 shows a cut through a large-scale wood-based material panel in the transverse direction;

FIG. 3 shows the top view of a large-scale wood-based material panel in depressions embossed in the longitudinal direction and the transverse direction;

FIG. 4 shows the simplified representation of a panel cut out from a large-scale wood-based material panel;

FIG. 5 shows a cut through a large-scale wood-based material panel in the transverse direction.

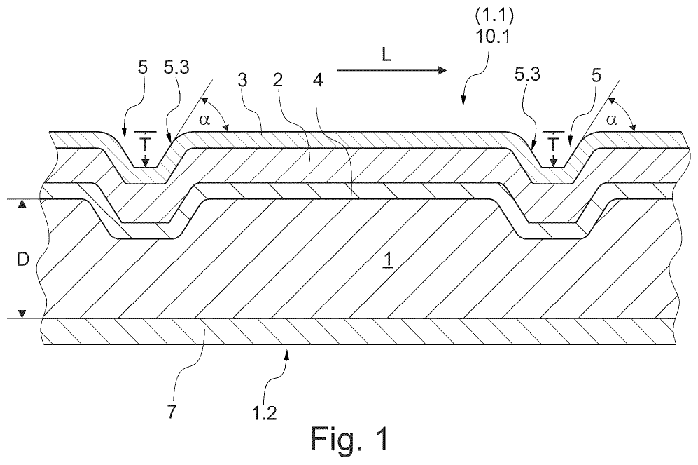

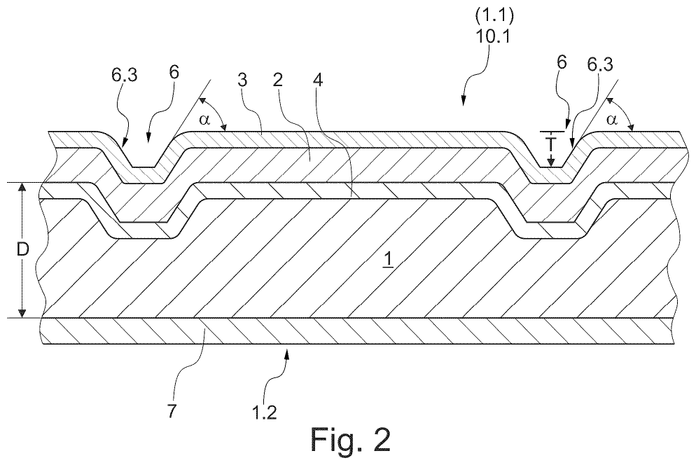

### DETAILED DESCRIPTION

An HDF panel with a thickness D of 7 mm forms the core 1 of a large-scale wood-based material panel. An underlay sheet 4 made of paper coated with a mixed resin is laid on the upper side 1.1 of the core 1. The mixed resin is a mix of phenolic resin and melamine resin. The mix ration of phenolic resin to melamine resin is two to one. A decorative layer 2 is laid on top of it, and a cover layer 3 is laid on top of that. The lower side 1.2 of the core 1 is provided with a backing layer 7. This structure is pressed in a short-cycle press for 30 seconds at a pressure of 60 kg/cm² and a temperature of 200° C. In order to emboss the depressions 5 extending in the transverse direction Q and the depressions extending in the longitudinal direction L into the upper side 10.1, a press plate is used in the short-cycle press, the former bearing trough-shaped elevations as ridges. The width of the ridges is approximately 2 cm and their height is 0.55 mm. During pressing, these ridges push through the cover layer 3, the decorative layer 2 and the underlay sheet 4 into the core 1 and form slightly V-shaped depressions 5, 6 in the cross-section. The side walls 5.3, 6.3 of the depressions 5.6 extend into the depth T at an angle α of 20° to 60°, preferably 45°, starting from the upper side 10.1. The steeper, the better.

The decorative layer 2 is formed by a resin-impregnated paper. A resin-impregnated overlay paper is also used for the cover layer 3, into which abrasion-resistant particles, especially corundum particles, can be mixed in order to increase its resistance to abrasion. The weight of the underlay sheet is 80 to 260 g/m², preferably at most 160 g/m². The paper is coated (impregnated) with 60 to 200 g/m² mixed resin.

Pressing was carried out with underlay sheets 4 with pure melamine resin and the mixed resin. The depth T of the depressions (structure depth) was between 0.4 and 0.48 mm, as can be seen in the following table:

| | | | Soda kraft |
|---|---|---|---|
| | Regenerate | Regenerate | paper 160 g/m² |
| | 80 g/m2 Pure | 80 g/m² (2X) | Mixed resin |
| Variation | melamine | pure melamine | (P/M, 2:1) |
| Test | (100% HA) | (100% HA) | (80% HA) |
| Overall layer thickness | 0.32 | 0.42 | 0.46 |
| Structure in mm | | | |
| Structure depth in mm | 0.4 | 0.4 | 0.48 |
| Pressing assessment | Disruption to | Micro-tears in | OK |
| | transparency | structuring | |

The grammages given in the column heads in the table represent the respective paper weight.

An overlay impregnate, a decorative impregnate and various underlay sheets were used in the process. The pressing process was carried out with identical press parameters. As is clearly shown, it is not possible to produce a flawless surface with an underlay sheet coated purely in melamine. Furthermore, it only resulted in a low structure depth. Even when two underlay sheets were used instead of one (middle trial).

The underlay sheets 4 were all impregnated with a phenolic-melamine resin, the ratio of phenolic resin to melamine resin being 2:1. The other impregnates (2, 3, 7) were impregnated under standard conditions, which also applies for the application of resin etc. Of course, this does not rule out impregnating the other impregnates (decorative paper 2, overlay 3 and/or backing layer 7) with the same mixed resin as the underlay sheet(s) 4. The overlays 3 used are intended for use class 23 of DIN EN 13329.

To confirm this surprising finding, pressing processes were also carried out with and without underlay sheets 4 using pure melamine resin and the mixed resin. The depth T of the depressions (structure depth) was between 0.32 and 0.41 mm.

The following table shows the results of a completed wood-based material panel with a core of a 7 mm thick HDF panel and a backing layer, without an underlay sheet, compared to three other wood-based material panels also with a core made of a 7 mm thick HDF panel with a backing layer, with underlays 4 with grammages of 80 g/m², 100 g/m² and 160 g/m². For the paper weight of 80 g/m², impregnation with 140 g/m² phenol-melamine mixed resin (2:1) was carried out; for the paper weight of 100 g/m² the underlay sheet 4 was impregnated with 75 g/m² phenol-melamine mixed resin (2:1); and for the paper weight of 160 g/m² the underlay sheet 4 was impregnated with 120 g/m² phenol-melamine mixed resin (2:1). The pressing process was carried out with identical press parameters. The overlay papers and decorative papers used were also identical.

| | | Trial structure | Trial structure | Trial structure |
|---|---|---|---|---|
| | Standard | 1 | 2 | 3 |
| Structure | Overlay, AC4 | Overlay, AC4 | Overlay, AC4 | Overlay, AC4 |
| | Decoration | Decoration | Decoration | Decoration |
| | HDF, 7 mm | Underlay sheet | Underlay sheet | Underlay sheet |
| | Backing layer | (80 g/m2)* | (100 g/m2)** | (160 g/m2)*** |
| | | HDF, 7 mm | HDF, 7 mm | HDF, 7 mm |
| | | Backing layer | Backing layer | Backing layer |
| Structure depth | 0.3 | 0.32 | 0.40 | 0.41 |
| in mm | | | | |
| Visual | Tears, | Slight | Slight | OK |
| assessment | disruption to | disruption to | disruption to | |
| | transparency | transparency | transparency | |
| Falling ball test | 500 | 500 | 750 | 750 |
| (DIN EN 13329) | | | | |
| Large ball | | | | |
| (in mm) | | | | |

*Soda kraft paper weight: 80 G/m2, end weight: 140 g/m2, resin coating: phenol/melamine mixed resin (2:1)
**Soda kraft paper weight: 100 G/m2, end weight: 175 g/m2, resin coating: phenol/melamine mixed resin (2:1)
***Soda kraft paper weight: 100 G/m2, end weight: 280 g/m2, resin coating: phenol/melamine mixed resin (2:1)

As shown in the table, in the case of an underlay sheet 4 with a grammage of 80 g/m², a depth of 0.32 mm of the depressions 5, 6 is achieved and the visual assessment still showed some slight disruptions to transparency, while with a standard panel a structure depth of just 0.3 mm was possible and the visual assessment showed tears and disruptions to transparency.

A flawless product in terms of quality was achieved from a grammage of 100 g/m² for the underlay sheet 4. A depth T of 0.40 mm for the depressions 5, 6 was possible and, when using an underlay sheet 4 with a grammage of 160 g/m², depressions 5, 6 with a depth T of 0.41 mm were achieved and the visual assessment produced no complaints.

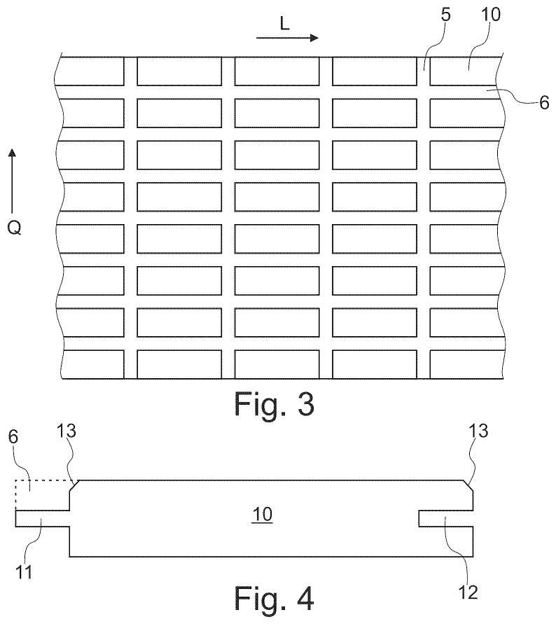

Soda kraft paper or recycled paper can be used as underlay sheets 4. Even though the trials were performed with a phenol-melamine resin, impregnation can also be done with pure melamine resin. Individual panels 10 are cut out of the coated wood-based material panel shown in FIG. 3 by making saw cuts along the depressions 5, 6. The lateral edges of the cut-out profile are machined. In this way, a tongue 11 and corresponding groove 12 are created on opposite lateral edges. The embossed depressions 5, 6 result in the formation of a resin-coated chamfer 13, starting from the upper side 10.1.

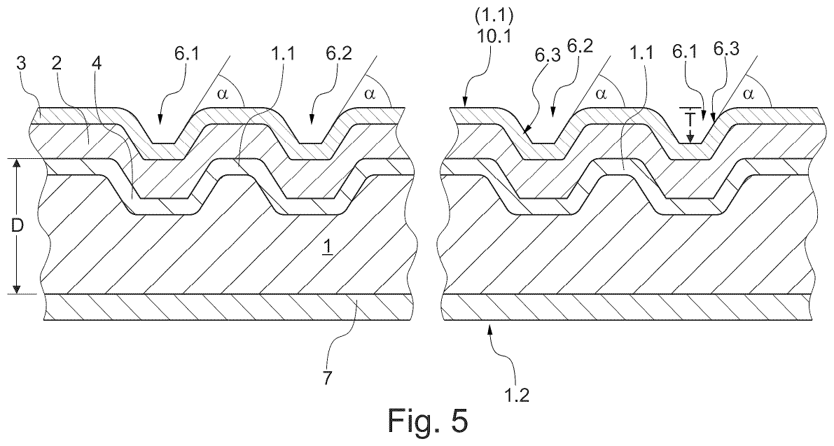

An alternative embodiment of the embossed large-scale wood-based material panel is depicted in FIG. 5. Here, two closely spaced depressions 6.1, 6.2 are embossed into the upper surface 10.1 of the large-scale wood-based material panel. When dividing the large-scale wood-based material panel into individual panels 10, the saw cut along the ridge 1.3 that forms between the depressions 6.1, 6.2 is sawn away and the lateral edge is then profiled. The depressions can be formed in pairs close to each other not only in the longitudinal direction L, but also in the transverse direction Q. The number of depressions 5, 6; 6.1, 6.2 is determined by the final desired size of the panels 10 and the dimensions of the large-scale wood-based material panel.

1. A wood-based material panel with a core, at least one decorative layer lying on an upper side above the core, under which at least one underlay sheet made of resin-coated paper is provided, at least one cover layer lying above the decorative layer, and at least one depression embossed into the upper side, wherein the resin is a mixed resin made of phenolic resin and melamine resin.

2. The wood-based material panel according to claim 1, wherein a ration of phenolic resin to melamine resin is 2:1.

3. The wood-based material panel according to claim 1, wherein a weight of the paper is 80 to 260 g/m² and a coating with resin is 60 to 200 g/m².

4. The wood-based material panel according to claim 1, wherein a coating with resin is at least 60 g/m².

5. The wood-based material panel according to claim 1, wherein at least one further embossed depression is provided, which is at a 90° diagonal angle to the depression.

6. The wood-based material panel according to claim 5, wherein a plurality of depressions is provided that extend parallel to each other.

7. The wood-based material panel according to claim 6, wherein plurality of the depressions have a depth of at least 0.4 mm.

8. The wood-based material panel according to claim 1, wherein the decorative layer is made of a resin-impregnated decorative paper.

9. The wood-based material panel according to claim 8, wherein a weight of the decorative paper is 60 to 160 g/m².

10. The wood-based material panel according to claim 1, wherein the cover layer is made of a resin-impregnated overlay paper.

11. The wood-based material panel according to claim 1, wherein the side walls of the depressions extend into a depth at an angle α of 20°-60°, starting from the upper side.

12. The wood-based material panel according to claim 1, wherein the core is an HDF panel.

13. A floor panel that has been produced after dividing the wood-based material panel according to claim 1 along the at least one depressions and after further machining steps for profiling the edges.

14. The wood-based material panel according to claim 1, wherein a coating with resin is at least 75 g/m².

15. The wood-based material panel according to claim 1, wherein a coating with resin is at least 120 g/m².

16. The wood-based material panel according to wherein the side walls of the depressions extend into the depth at an angle α of 45°, starting from the upper side.
